(19) United States
(12) Patent Application Publication
(10) Pub. No.: US 2022/0010239 A1
(43) Pub. Date: Jan. 13, 2022

(54) DETERGENT POLYMER AND COMPOSITION

(71) Applicant: ITALMATCH CHEMICALS S.P.A., Arese MI (IT)

(72) Inventors: Frédéric BRUYNEEL, Monza MB (IT); Fabio COSTINITI, Vigodarzere PD (IT); Diego BOSCARDIN, Barlassina MB (IT); Eric KOAY, Gerenzano VA (IT); Ruggero SALA, Parabiago MI (IT)

(21) Appl. No.: 17/282,171

(22) PCT Filed: Oct. 3, 2019
(86) PCT No.: PCT/IB2019/058417

§ 371 Date: Apr. 1, 2021

(30) Foreign Application Priority Data
Oct. 3, 2018 (IB) PCT/IB2018/057692

(51) Int. Cl. C11D 3/37; C08G 73/10; C11D 11/00

(52) U.S. Cl. CPC C11D 3/3719; C11D 11/0023; C11D 11/0017; C08G 73/1092

(57) ABSTRACT

The present invention refers to a novel polymer that possesses metal ion removal properties, compositions comprising it, its use in cleaning application and the process for its manufacture. The present invention also relates to an improved the process for the manufacturing of known polymer as well, and the use of these known polymers in cleaning applications.

### SUMMARY

The present invention refers to a novel polymer that possesses metal ion removal properties, compositions comprising it, its use in cleaning application and the process for its manufacture. The present invention also relates to an improved the process for the manufacturing of known polymer as well, and the use of these known polymers in cleaning applications.

### STATE OF THE ART

Detergents are chemical compositions with cleaning properties that can be used for domestic and industrial applications, e.g. dishwashing or laundry applications, and other industrial applications.

Detergents are typically used along tap water in every application thereof. Tap water is considered a “hard water”, as it contains cations such as calcium, magnesium and other ions that can cause the formation of soap scum, reducing or inhibiting the cleaning properties of detergents.

Moreover, in addition to soap scum, heavier metal cations, i.e. multivalent transition metal cations (iron (Fe³⁺) in particular), are relevant in the formation of stain complexes on many surfaces, including fabric, ceramic or glass surfaces, enhancing the binding of the components of many stains to such surfaces and making such stains even more difficult to clean.

For the reasons stated above, detergents comprise chemicals known as “builders” (also known as complexation agents or sequestering agents), which actively remove cations that are normally present in hard water, thus softening the water. Builders remove metal cations through either chelation or ion exchange. “Co-builders”, which are also chemicals often comprised in conventional detergents, are used in cleaning application (usually in less amounts than builders) because they enhance the activity of builders, i.e. complexing and/or sequestering and/or chelating ions.

Phosphorus-based builders were introduced during the 1940s, for example sodium triphosphate and subsequently etidronic acid (HEDP), aminotris (methylenephosphonic acid) (ATMP), ethylenediamine tetra (methylene phosphonic acid) (EDTMP) and diethylenetriamine penta(methylene phosphonic acid) (DTPMP). Phosphorus-based builders show very effective ion removing properties, however they also cause serious environmental damages because they are poorly biodegradable.

Due to environmental concerns, phosphate-free (P-free) builders and co-builders, such as ethylenediaminedisuccinic acid (EDDS) or sodium polyaspartate, are now commonly used in deterging and cleaning applications. Indeed, these builders are biodegradable, and thus can be included in detergent compositions without environmental concerns. However, the ability of removing metal ions (especially multivalent transition metal cations) of P-free builders and co-builders is not satisfactory, and detergents including them may not provide appropriate stain and spot removal. Moreover, when used in dishwashing applications, phosphate-free compositions leave an insoluble visible deposit after the dishes, glasses or cutleries are dried.

For the above reasons, it is required a detergent component effective in removing cations (including transition metal cations) while being environmentally friendly (i.e. biodegradable), and providing effective stain and spot removal when included in detergent compositions.

### OBJECTS OF THE INVENTION

Object of the present invention is to provide a novel polymer, which overcomes disadvantages of conventional phosphonates and P-free builders and co-builders, namely respectively environmental harm and unsatisfactory metal ion removal, especially in case of presence of multivalent transition metal cation.

Also object of the present invention is to provide a novel polymer that is versatile, i.e. that can be used effectively in several cleaning applications, for example in both domestic and industrial laundry and dishwashing applications, as well as for effective removal of several types of stains and spots, when included in detergent compositions.

Further object of the present invention is to provide a detergent composition comprising such novel polymer, thus providing advantages such as effective stain and spot removal and improved biodegradability.

Another object of the present invention is to provide a use for said novel polymer.

Further object of the present invention is to provide a process for the preparation of such novel polymer and an improved process for the preparation of a known polymer.

These and others objects are achieved by the subject-matters disclosed below and by their embodiments.

### DESCRIPTION OF THE INVENTION

Subject-matter of the present invention is an aspartic acid/N-hydroxyaspartamide/succinimide polymer and/or its salts, characterized in that it comprises non-hydrolyzed succinimide units. Preferably, the polymer of the invention comprises non-hydrolyzed succinimide units in the range of 10% to 90%, more preferably of 50% to 80%, even more preferably of 60% to 70%, with respect to the total number of repeat units in the polymer.

The polymer of invention comprises also aspartic acid repeat units and N-hydroxyaspartamide repeat units other than non-hydrolyzed succinimide units. The polymer of the invention can be therefore obtainable by reacting poly-succinimide with a hydroxylamine, preferably according to the process of the invention disclosed below.

According to the present invention, it is essential that the polymer of the invention formulated as solid comprises at least some succinimide repeat units (non-hydrolysed) in its structure. Such repeat units are preferably at least 10% or more of the total number of repeat units in the polymer, up to 90%. It has been surprisingly found that the polymer of the invention possesses great ion chelation properties and biodegradability.

Indeed, as it can be observed in the experimental section, the polymer of the invention exerts ion chelation properties that are greatly improved with respect to conventional P-free polymer (i.e. poly-aspartic acid, PASP), and is comparable with respect to those of conventional phosphorous-based builders and co-builders. Moreover, as it can also be observed from the experimental section, the polymer according to the invention is useful in many detergent applications, especially in domestic and industrial cleaning application, such as laundry and dishwashing cleaning application (both manual and automatic), and in removing several types of stains and spots. Indeed, an advantage of the polymer of the invention is its versatility.

As succinimide is not soluble in aqueous medium, whereas aspartic acid and N-hydroxyaspartamide are, the polymer of the invention is in solid form when in aqueous medium, and therefore forms a suspension. The state of matter of the polymer of the invention when in aqueous medium can be an indication of the presence of non-hydrolyzed succinimide units. As said above, such units have to be comprised in the polymer of the invention for it to exert its advantageous properties. In the present invention, “N-hydroxyaspartamide” refers to derivatives of aspartic acid repeat units bearing a hydroxamic acid moiety instead of the carboxylic acid moiety. For example, N-hydroxyaspartamide are the repeat units (iv) and (v) of Formula I below, which represents an illustrative example of the polymer of the invention.

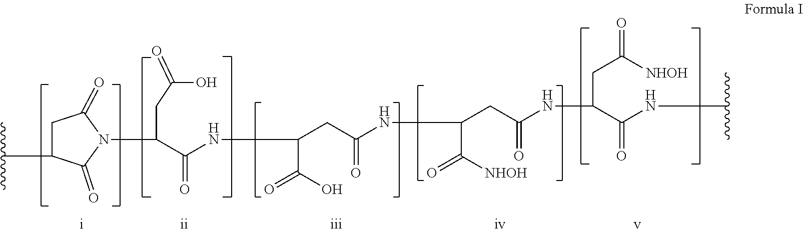

wherein the succinimide units are preferably comprised in a range of 10% to 90%, more preferably of 50% to 80%, even more preferably of 60% to 70%, of the total number of repeat units in the polymer.

The relative positions of the aspartic acid repeat units and of the N-hydroxyaspartamide repeat units in the polymer of the invention are determined by its process of synthesis. According to a preferred aspect of the invention, the relative positions of aspartic acid repeat units (i.e. repeat units ii and iii according to Formula I), N-hydroxyaspartamide repeat units (i.e. repeat units iv and v according to Formula I) and non-hydrolyzed succinimide repeat units (i.e. repeat units i according to Formula I) along the chain of the polymer are essentially random when the polymer of the invention is synthesized starting from poly-succinimide and hydroxylamine. Randomly alternating the repeat units of the polymer of the invention may enhance its metal chelating effectiveness by providing different spacing between functional chelating groups, thus allowing the polymer of the invention to sequester a wider variety of cations. Therefore, the repeat units are preferably randomly bonded in the polymer of the invention, thus advantageously providing a random copolymer.

The polymer of the invention preferably comprises succinimide units in the range of 10% to 90%, more preferably of 50% to 80%, even more preferably of 60% to 70%, with respect to the total number of repeat units in the polymer. The polymer of the invention comprising succinimide units in these preferred ranges showed great effectiveness in application tests.

According to the present invention, the polymer may also be in salt form, e.g. it can be a Na⁺, K⁺, Li⁺, Ag⁺, NH₄⁺, salt form.

According to another preferred embodiment of the invention, the molecular weight of said polymer is comprised in the range of 400 to 5000 Da, preferably of 600 to 3500 Da, and more preferably of 800 to 2500 Da. The polymer of the invention possessing the molecular weights above mentioned can be obtained by reacting hydroxylamine with poly-succinimide having a molecular weight of 1 to 50 KDa, preferably 3 to 50 KDa, more preferably of 5 and 20 KDa, and more preferably of 5.5 and 10 KDa, and by adding basic reagents in one or more steps, for example according to embodiments of the process of the invention. According to this preferred embodiment, the polymer of the invention has lower molecular weight with respect to conventional polymers usually involved in chelation of ions and/or included in detergent compositions. This provides technological advantages, e.g. less viscous solutions are obtained when a given concentration of the polymer according to the invention is dissolved in a detergent composition, with respect to the solution obtained by dissolving the same concentration of a conventional polymer with higher molecular weight in the same detergent composition. Moreover, it was found that the polymer having the molecular weight as disclosed above provides suitable biodegradability, and is thus environmentally-friendly.

Unless otherwise specified, the molecular weight of the present invention are determined by gel permeation chromatography (GPC) using calibration made with standard samples of poly-acrylates sodium salts (PaaNa) of known molecular weight (1 KDa to 30 KDa). GPC was carried out with Agilent Infinity II 1260 using 2 columns (in series) PL aquagel-OH 20 8 μm 7.5×300 mm, using a mobile phase made of Buffer phosphate at pH 7.2 and a flow set at 1 mL/min, and a refractive index (RI) detector. All sample were first diluted to 0.5 wt % and filtered on 0.2 μm. The molecular weight of starting material poly-succinimide was determined by carrying out a GPC analysis slurrying 1.0 g samples of the product with 1.0 g of water and dissolved in 0.9 g 40% aqueous NaOH to give clear light tan solutions of sodium poly-aspartate.

As demonstrated in the experimental section below, the polymer of the invention exerts good builder and co-builder activity when included in detergent compositions and when used in cleaning applications. Indeed, the polymer of the invention provides good properties in capturing ions, in particular ions deriving from transitional metals. Moreover, the polymer of the invention provides better ion removal with respect to known P-free builders, and comparable ion removal with respect to known phosphorus-based builders.

Additionally, the polymer of the invention is environmentally friendly. Indeed, as demonstrated in the experimental section below, it has favorable biodegradation properties, allowing it to be used without concerns to the environment. This aspect is particularly important, for example when the polymer according to the present invention is used in detergent compositions.

Therefore, the polymer of the invention overcomes the disadvantages of both known phosphate builders (which cause environmental damages) and known P-free builders (that show not satisfactory cation removal properties), by providing both good scale inhibiting performances and biodegradability.

Moreover, the polymer of the invention is useful in several cleaning applications, especially in domestic and industrial cleaning, like in laundry and dishwashing applications. In the present invention, “laundry and dishwashing applications” or similar terms refer to both manual and automatic laundry and dishwashing applications, preferably to automatic laundry and dishwashing applications.

Another subject-matter of the present invention is a detergent composition comprising the polymer of the invention according to any of its embodiments and suitable excipients.

Preferably, said polymer of the invention is comprised in concentration from 0.1% to 3% weight/weight (w/w) with respect to the total weight of the composition, more preferably from 0.3% to 2% w/w, even more preferably 0.6% w/w, in said detergent composition.

As shown in the experimental section below, the polymers of the invention afford good metal cation removal properties, and they thus act as builders or co-builders. Therefore, according to the present invention, the polymer of the invention is advantageously included in the detergent composition for its builder or co-builder activity. In other words, polymer of the invention is advantageously included in the detergent composition as builder or co-builder.

The detergent composition of the invention is versatile and effective in several cleaning applications: as it will be shown in the experimental section below, it is able to remove or prevent effectively different kind of stains on both dishwashing and laundry applications.

The detergent composition of the invention comprises also additional suitable excipients other than the polymer of the invention.

For example, the detergent composition of the invention may comprise at least one detergent surfactant. Such at least one detergent surfactant may be present in amounts usually encountered in detergent compositions, e.g. from about 1% to about 50% by weight based on the total weight of the detergent composition. Such surfactant may be anionic, nonionic, cationic or amphoteric, and mixtures of different surfactants may be used.

Furthermore, when the polymer of the invention is used as a co-builder in the detergent composition of the invention, such detergent composition may comprise also conventional builders, for example condensed phosphates, such as sodium hexameta phosphate (SHMP), sodium tripolyphosphate (STPP), trisodium nitrilotriacetate (NTA), sodium carbonate, zeolites, sodium silicates, polyacrylates, polymaleates and polymethacrylates. When present, said conventional builders may be in amounts ranging from about 10% to about 50% by weight of the total weight of the detergent composition.

Moreover, the detergent composition of the invention may also comprise other suitable excipients used in cleaning applications, such as lather boosters (e.g. alkanolamides), fillers, antiredeposition agents, fluoresces, pigments, germicides, scents and enzymes.

Any conventional manufacturing process may be used to prepare the detergent composition of the invention. For example, the detergent composition of the invention can be manufactured by first preparing a slurry and then spraying-drying said slurry.

The detergent composition of the invention can be provided and used in any of the common formulations associated with detergents, e.g. powders, flakes, granules, noodles, cakes, bars and liquids, and can be prepared as any of such forms, according to conventional manufacturing methods.

Another subject-matter of the present application is the use of the polymer of the invention in cleaning applications.

In the present invention, cleaning applications or similar terms refer to applications wherein the reduction or removal of any kind of stain and/or dirt and/or spot is needed. These applications include, for example, domestic and industrial cleaning applications, e.g. dishwashing or laundry applications, and additional industrial applications.

An aspect of the present invention is also the use of the polymer as a builder in cleaning applications, as well as the use of the polymer as a co-builder in cleaning applications. Indeed, as it will be shown in the experimental section below, the polymer of the invention is useful for complexing and/or sequestering and/or chelating ions.

Additionally, the use of the polymer of the invention as builders or as co-builders in detergent compositions is also a subject-matter of the present invention. Preferably, said polymer is used in concentration of about 0.1% to about 3% weight/weight (w/w) with respect to the total weight of the composition, more preferably of about 0.3% to 2% w/w, even more preferably of about 0.6% w/w, in detergent compositions.

According to the use of the invention, said cleaning applications are advantageously dishwashing cleaning and/or laundry cleaning, preferably are automatic dishwashing cleaning and/or laundry cleaning. For example, the polymer of the invention may be used for cleaning and/or deterging garments, dishes, cutleries, fabrics, glasses, yarns, ceramics, carpets, upholstery, etc.

Also subject-matter of the present invention is a process for the synthesis of the polymer according to claim 1 comprising the following steps:

a) providing a solution of a salt of hydroxylamine;

b) adding poly-succinimide to said solution of step a), whereby allowing the reaction of said poly-succinimide with said salt of hydroxylamine; and

c) adding basic reagents in one step or in more than one step after addition of said poly-succinimide in step b) is over;

characterized in that said process is carried out by controlling the ring opening of said poly-succinimide so that said polymer resulting from step c) comprises non-hydrolyzed succinimide units.

The process of the inventions provides the polymer of the invention, which in turn provides every advantage mentioned above.

The process of the invention has to be carried out ensuring the control of the ring opening of the starting material poly-succinimide, so that some succinimide repeat units are still present as such in the final product; preferably, 10% to 90% succinimide repeat units, with respect to the total number of repeat units are still present as such. In other words, according to the process of the invention, succinimide repeat units of the starting material poly-succinimide must not completely react with hydroxylamine (forming N-hydroxyaspartamide repeat units), and/or must not completely be cleaved (for example, by basic hydrolysis of the poly-succinimide-forming aspartic acid repeat units), because succinimide repeat units must be still present in the final product (i.e., the polymer of the invention).

In current practice, polymeric components of detergent compositions are conventionally synthesized in their liquid form (i.e. dissolved in the reaction mixture) and are then recovered after their conversion into solid or semi-solid form, for example by dialysis followed by lyophilisation, spray drying, and other technologies, such as fluid beds, desiccators, agglomerators, frequently with the help of carriers. An advantage of the process of the invention is providing the final product (i.e. the polymer of the invention) directly in its solid form, thus avoiding the further steps conventionally needed to convert the dissolved detergent polymer in its solid or semi-solid form. According to the process of the invention, the final product, i.e. the polymer of the invention, is directly synthesized in solid form and can be therefore easily recovered, e.g. by filtration or centrifugation.

Another advantage of obtaining the final product of the process of the invention in solid form is that none of the small molecular weight byproduct are retained as impurity, because the final product obtained as a dispersed suspension is easily recovered, for example by filtration.

According to the process of the invention, the control of the poly-succinimide ring opening can be carried out by providing a solution of a salt of hydroxylamine in step a), and by adding basic reagents in one step or in more than one step after the addition of poly-succinimide in step b) is over. Preferably, such addition of basic reagents is carried out in more than one step. One or more of the steps of such addition of basic reagent can be carried out at a temperature comprised in the range of 20° C. to 80° C. for a time comprised in the range of 0.5 to 3 hours. Moreover, after some or every addition of basic reagent, preferably after every addition of basic reagent, the reaction mixture can be further kept at a temperature comprised in the range of 20° C. to 80° C. for a time comprised in the range of 0.5 to 3 hours. For example, two steps of addition of basic reagent at a temperature comprised in the range of 20° C. to 80° C. for a time comprised in the range of 0.5 to 3 hours can be carried out, and after the second step of addition the reaction mixture can be kept at about 40° C. for 1 hour. It has been found that control of the poly-succinimide ring opening carried out according to the above leads to higher conversion of succinimide units into hydroxamic acid and/or N-hydroxyaspartamide units.

Suitable basic reagents can be known bases, for example metal hydroxides such as sodium hydroxide and potassium hydroxide, amines, such as MEA and TEA, and ammonium.

The amount of succinimide units cleaved in the poly-succinimide starting material depends on the amount of basic reagent added. Adding in total a sub-stoichiometric amount (between the one or more addition steps) of basic reagent, with respect of the initial amount of succinimide units found in the poly-succinimide, provides a solid final product. For example, adding a total of 40 mole % of basic reagent with respect of the initial amount of succinimide units found in the poly-succinimide starting reagent provides a solid final product.

The solution of step a) can be prepared by dissolving hydroxylamine in any suitable solvent. Preferably, such solvent is a polar solvent, more preferably is a polar protic solvent, and even more preferably is water. The solution of step a) is preferably prepared by dissolving a hydroxylamine salt in the suitable solvent at a temperature below 60° C., for example about 40° C., until an homogeneous solution is formed.

Poly-succinimide is not soluble in the solvent used to prepare the solution of step a). Therefore, the addition of poly-succinimide to the solution of step a) provides a suspension; accordingly, the addition of step b) is preferably carried out portion wise, whereby a stirrable suspension is provided.

At the end of the reaction between the poly-succinimide and hydroxylamine and before collecting the polymer of the invention so obtained, the eventual residual hydroxylamine reagent is preferably destroyed/inactivated in the so-called bleaching step by adding about 0.5 to 1 wt % of oxidant, such as hydrogen peroxide.

According to embodiments, the molecular weight of the starting poly-succinimide added in step b) is comprised in the range of 1 to 50 KDa, preferably of 2 and 20 KDa, and more preferably of 4.5 and 10 KDa. According to this embodiment, the final product is a polymer of the invention that has low molecular weight, e.g. the molecular weight ranges disclosed above. The final product, i.e. the polymer of the invention, has lower molecular weight with respect to conventional polymers usually involved in chelation of ions and/or utilized in detergent compositions. This provides the technological and surprising advantages already stated above.

According to embodiments, the molar ratio of hydroxylamine/succinimide repeat units of the starting poly-succinimide is 0.2/1.

Also subject-matter of the present application is a process for the preparation of an aspartic acid/N-hydroxyaspartamide/succinimide derived polymer and/or its salts, comprising the following steps:

a′) providing a solution of a salt of hydroxylamine;

b′) adding poly-succinimide to said solution of step a′), whereby allowing the reaction of said poly-succinimmide with said salt of hydroxylamine; and

c′) adding basic reagents in one step or in more than one step after addition of said poly-succinimide in step b′) is over;

characterized in that said process is carried out by controlling the ring opening of said poly-succinimide so that said polymer resulting from step c′) does not comprise succinimide units.

The latter process of the invention provides an improved process with respect to those processes known in the art that provides the same polymer, i.e. an aspartic acid/N-hydroxyaspartamide derived polymer as above defined, as it leads to higher conversion of succinimide units into aspartic and/or N-hydroxyaspartamide units (i.e hydroxamic).

The polymer provided by the latter process of the invention is an aspartic acid/N-hydroxyaspartamide polymer that does not comprise non-hydrolyzed succinimide units, as every one of the succinimide unit (present in the starting reagent poly-succinimide) is cleaved and/or reacts with hydroxylamine. The polymer provided by the latter process of the invention is in its liquid form when in aqueous media, as it dissolves therein. It was found that such polymer having excellent biodegradability profile can be effectively used in cleaning application too.

Therefore, the latter process of the invention differs from the first process of the invention as it aims to provide a polymer not comprising succinimide units. According to the present invention, by adding basic reagents according to step c) or c′) it is possible to control the ring opening of said poly-succinimide, and in turn to control which final product polymer is obtained. In general, a solid final product is obtained if succinimide units (e.g. from 10% to 90%) are still comprised in the final product (first process of the invention); alternatively, a liquid final product is obtained if no succinimide unit is comprised in the final product (latter process of the invention).

According to the latter process of the invention, adding in total a stoichiometric amount (between the one or more addition steps), or more than stoichiometric amount, of basic reagents with respect to the initial amount of succinimide units found in the poly-succinimide provides cleaving and/or reaction with hydroxylamine of every succinimide units of the poly-succinimide starting reagent, thereby providing a liquid final product (i.e. a product that is dissolved in the aqueous reaction mixture). For example, adding a total of 100 mole %, or a total of 180 mole % of basic reagent with respect of the initial amount of succinimide units found in the poly-succinimide starting reagent provides a liquid final product.

Subject-matter of the present invention is also a polymer obtainable according to the latter process of the invention, as well as the use of such polymer in cleaning applications. Experimental data obtained by various tests (reported in the experimental section below) show that the polymer obtainable according to the latter process of the invention is effective in several cleaning application.

The invention will be further disclosed according to the following figures and examples, which are provided only for illustrative purposes and are not meant to limit the scope of the invention.

### DESCRIPTION OF THE FIGURES

FIG. 1 is a spectrogram of a ¹³C-NMR spectroscopic analysis of a polymer obtained by the process of the invention.

FIG. 2 is a graph representing the stain removal results of a laundry washing test comparing the detergent composition comprising the polymer of the invention and a detergent composition comprising EDTMPA Na+ salt+ HEDP Na+ salt according to the prior art.

FIG. 3 is a graph representing the stain removal results of a laundry washing test comparing the detergent composition comprising the polymer of the invention and a detergent composition comprising DTMPA Na+ salt+HEDP Na+ salt according to the prior art.

FIG. 4 is a graph representing the stain removal results of a laundry washing test comparing the detergent composition comprising the polymer of the invention and a detergent composition comprising EDDS according to the prior art.

FIG. 5 is a graph representing the spot prevention results of a dishwashing test comparing the detergent composition comprising “Base A”+the polymer of the invention, and a detergent composition comprising “Base A”+HEDP according to the prior art.

FIG. 6 is a graph representing the filming prevention results of a dishwashing test comparing the detergent composition comprising “Base A”+the polymer of the invention, and a detergent composition comprising “Base A”+HEDP according to the prior art.

FIG. 7 is a graph representing the spot prevention results of a dishwashing test comparing the detergent composition comprising “Base B”+the polymer of the invention, and a detergent composition comprising “Base B”+HEDP according to the prior art.

FIG. 8 is a graph representing the filming prevention results of a dishwashing test comparing the detergent composition comprising “Base B”+the polymer of the invention, and a detergent composition comprising “Base B”+HEDP according to the prior art.

### EXPERIMENTAL SECTION

Unless otherwise specified, the molecular weight of the present invention are determined by gel permeation chromatography (GPC) using calibration made with standard samples of poly-acrylates sodium salts (PaaNa) of known molecular weight (1 KDa to 30 KDa). GPC was carried out with Agilent Infinity II 1260 using 2 columns (in series) PL aquagel-OH 20 8 μm 7.5×300 mm, using a mobile phase made of Buffer phosphate at pH 7.2 and a flow set at 1 mL/min, and a refractive index (RI) detector. All sample were first diluted to 0.5 wt % and filtered on 0.2 μm. The molecular weight of starting material poly-succinimide was determined by carrying out a GPC analysis slurrying 1.0 g samples of the product with 1.0 g of water and dissolved in 0.9 g 40% aqueous NaOH to give clear light tan solutions of sodium poly-aspartate.

### Example 1

Synthesis of the Polymer of the Invention

### Example 1.1

Synthesis of the Polymer of the Invention in Solid Form

1.8 Kg of water are introduced into a stirred vessel with a capacity of 5 L and heated to 40° C. 0.24 Kg of solid hydroxylammonium sulfate salts (purity >95%) are added in one portion and the mixture is stirred for 15 min until a homogeneous solution is formed. 1.5 Kg of commercial poly-succinimide having a determined MW of 6.1 KDa is added portion wise to the stirred vessel to produce a steerable suspension. 0.358 Kg of 47% strength aqueous potassium hydroxide solution are metered into this suspension at a temperature not exceeding 45° C. during 2 hours. The mixture is then stirred at 40° C. for 1 hour. Then 0.36 Kg of 47% strength aqueous sodium hydroxide solution are metered into this suspension at a temperature not exceeding 40° C. during 2 hours. Then, after 1 additional hour, 0.001 Kg of 30% strength aqueous hydrogen peroxide solution is added as final bleaching step for 1 hours. The temperature is then decreased to 30° C. The amount of sodium hydroxide solution added is 40 mole % with respect to the initial amount of succinimide units found in the poly-succinimide. The suspension is then filtered using a lab scale centrifuge (Rousselet Robatel, type RA 20VxR, serial nbr 25102), running at 200 rpm and equipped with polypropylene filter basket of 120 mm mesh. The solid recovered is further air dried, providing 1.1 Kg of a light orange powder corresponding to more than 70% recovery yield. Molecular weight of the final polymer in around 2.5 KDa.

### Example 1.2

Synthesis of the Polymer of the Invention in Liquid Form 0.79 Kg of water are introduced into a stirred vessel with a capacity of 2 L and heated to 40° C. 0.08 Kg of solid hydroxylammonium sulfate salts (purity >95%) are added in one portion and the mixture is stirred for 15 min until a homogeneous solution is formed. 0.48 Kg of commercial poly-succinimide having a determined MW of 5.3 KDa was added portion wise to the stirred vessel to produce a steerable suspension. 0.079 Kg of 49% strength aqueous sodium hydroxide solution are metered into this suspension at a temperature not exceeding 60° C. during 30 min. The mixture is then stirred at 60° C. for 3 hours. Then 0.4 Kg of 49% strength aqueous sodium hydroxide solution are metered into the suspension at a temperature not exceeding 70° C. during 1 hour. Then, after 1 hour, 0.2 Kg of 49% strength aqueous sodium hydroxide solution are added over the course of 1 hour, and the reaction mixture is stirred at 60° C. for 1 hour. The temperature is then decreased to 30° C. and 0.003 Kg of a 30% strength aqueous hydrogen peroxide solution is added as final bleaching step. The amount of sodium hydroxide solution added is 180 mole % with respect to the initial amount of succinimide units found in the poly-succinimide. The solution has a pH of 10 and a solid content of 42% by weight (determined by drying at 125° C. using thermobalance). The polymer has a MW of 2.2 KDa.

### Example 1.3

Synthesis of the Polymer of the Invention in Liquid Form

The liquid product of Example 1.2 is introduced into a stirred vessel with a capacity of 2 L and heated to 70° C. 0.2 kg of 49% strength aqueous sodium hydroxide solution are added over the course of 1 hour, and the reaction mixture is stirred at 60° C. before being cooled down again to 30° C. The solution has a pH of 11 and a solid content of 38% by weight (determined by drying at 125° C. using thermobalance). The polymer has a MW of 1.1 KDa. The polymer product of the present example has been found having improved biodegradability properties.

### Example 1.4

Synthesis of the Polymer Invention in Liquid Form—Industrial Pilot Scale

350 Kg of water are introduced into a stirred vessel with a capacity of 1000 L and heated to 40° C. 41 kg of solid hydroxylammonium sulfate salts (purity >95%) are added in 2 portions and the mixture is stirred for 15 min until a homogeneous solution is formed. 238 Kg of commercial poly-succinimide having a determined MW of 5.3 KDa is added portion wise to the stirred vessel to produce a steerable suspension. 40 Kg of 49% strength aqueous sodium hydroxide solution are metered into this suspension at a temperature not exceeding 60° C. over 30 min. The mixture is then stirred at 60° C. for 2 hours. Then 198 Kg of 49% strength aqueous sodium hydroxide solution are metered into the suspension at a temperature not exceeding 65° C. over 1 hour. Then, after 1 hour, 125 kg of 49% strength aqueous sodium hydroxide solution are added over the course of 1 hour, and the reaction mixture is stirred at 60° C. for 1 hour. Then and 2 Kg of a 30% strength aqueous hydrogen peroxide solution are added as final bleaching step before letting the product cool down to 30° C. The amount of sodium hydroxide solution added is 182 mole % with respect to the initial amount of succinimide units found in the poly-succinimide. The solution has a pH of 12, a solid content of 43% by weight, and a density of 1.3 g/mL. The polymer has a MW of 1.16 KDa. The pH was further adjusted to 10 by diluting with 54 Kg of a 50% strength aqueous sulfuric acid. The solid content was increased to 46 wt % (determined by drying at 125° C. using thermobalance).

### Example 1.5

Synthesis of the Polymer of the Invention in Liquid Form

0.3 Kg of water are introduced into a stirred vessel with a capacity of 1 L and heated to 40° C. 0.25 Kg of commercial poly-succinimide having a determined MW of 6.1 KDa is added portion wise to the stirred vessel to produce a steerable suspension. 0.035 Kg of solid hydroxylammonium chloride (purity >95%) are dissolved into 0.15 Kg of water, neutralised by addition of 0.05 Kg of a 50% strength aqueous sodium hydroxide solution, and are metered in the mixture. The mixture is stirred at 40° C. for 3 hours. 0.16 Kg of 50% strength aqueous sodium hydroxide solution are metered into this suspension again at a temperature not exceeding 45° C. over 30 min. The mixture is then stirred at 45° C. for 2 hours. The temperature is then decreased to 30° C. and 0.0165 Kg of a 30% strength aqueous hydrogen peroxide solution is added as final bleaching step. The amount of sodium hydroxide solution added is 99 mole % with respect to the initial amount of succinimide units found in the poly-succinimide. The Solution has a pH of 8 and a solid content of about 40% by weight (determined by drying at 125° C. using thermobalance). The polymer has a MW of 2.3 KDa.

### Example 1.6

Synthesis of the Polymer Invention in Liquid Form—No Bleaching Step

The same reaction as for Example 1.5 is conducted without the final bleaching step. The solution has a pH of 8.8 and a solid content of about 40% by weight; determined by drying at 125° C. using thermobalance). The polymer Has a MW of 2.35 KDa.

### Example 2

¹³C-NMR Spectroscopic Analysis

An analysis carried out to the polymer obtained in Example 1.5 above provided the following results

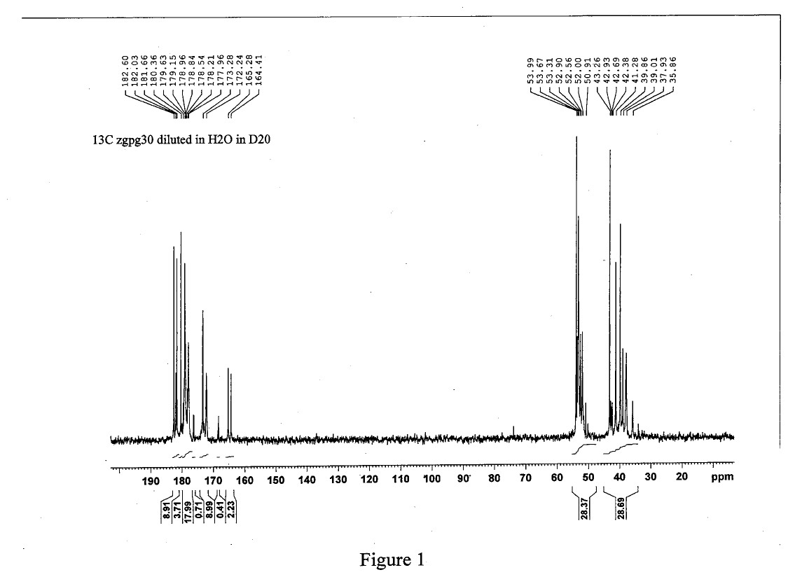

FIG. 1 is the spectrum obtained by the analysis of the present example.

¹³C-NMR (H2O/D2O):181 to 177 ppm (C═O β-peptide) and (C═O α-peptide), 176 to 172 ppm (CONH β-peptide) and (CONH α-peptide), 165 and 164 ppm (hydroxamate β-peptide) and (hydroxamate α-peptide) 51.38 ppm (C(α).β.-peptide), 39 ppm (C(β),α-peptide), 37.69 (C(β), β-peptide).

The assignment of the relevant signals was carried out in accordance with Makromol. Chem. 194, 1095 (1993).

### Example 3

### Application Examples

### Example 3.1

Removal of Fe³⁺ (Modified Hampshire Test)

The principle of the modified Hampshire test is as follows: it is a titration analysis where the complexing agent (e.g. the polymer of the invention or comparative builders) is added to water at pH 10-11, and then a solution of FeCl₃ is added to the same water. When the complexing capacity of the complexing agent is exhausted, a brown precipitation of Fe(OH)₃ can be observed. The test runs at room temperature. Test procedure (at room temperature) is as follows: dilute 0.80 g (±0.01 g) of complexing agent (the ones cited on Table 1) in 750 ml of distilled water in a beaker. Adjust pH between 10 and 11 by adding NaOH or HCl as required. Add stepwise a 0.25 M solution of FeCl₃ until the beaker content becomes turbid (i.e. until Fe(OH)₃ precipitates) and record the volume of FeCl₃ solution used (titration volume). During FeCl₃ addition, keep pH between 10 and 11 by adding stepwise a solution of NaOH. After the precipitation, control pH and fill up with distilled water to 800 ml. To determine the exact titration volume, make additional tests, in different beakers, repeating the steps above but adding smaller amounts of the solution of FeCl₃ starting from the titration volume previously determined (approximately: first titration volume minus 2 ml, 4 ml, 6 ml, etc.). After 3 hours, observe the beaker content. Record the titration volume of the beaker in which the first traces of brown precipitation can be observed: these ml minus 2 ml is the titration volume.

Calculation of Fe(III) chelation is done as follows:

$$Fe ( III ) chelation ( mg / g ) = \frac{ml FeCl3 solution added * 13.6}{0.8 g of complexing agent}$$

TABLE 1

| Complexing Agent | Fe³⁺ chelation (mg/g) |
|---|---|
| Sodium polyaspartate (P-free | 200 |
| (comparative)) | |
| HEDP (containing | 1250 |
| phosphorous (comparative)) | |
| Polymer of the invention | 950 |

The polymer of the invention used for the present example is the one prepared according to Example 1.1 above

HEDP (etidronic acid) is a known phosphorus based additive in cleaning. Sodium polyaspartate (PASP) is a known P-free and biodegradable builder and co-builder.

Results of the present example show that the polymer of the invention is able to chelate an amount of Fe³⁺ almost 10 times higher compared to sodium polyaspartate, a known and widely used P-free builder. Moreover, the polymer of the invention provides comparable chelating properties with respect to HEPD, which is a known phosphorous-based chelating agents, i.e. the most effective chelating agents known in cleaning applications, yet not biodegradable. Therefore, the polymer of the invention possesses surprising chelating properties, comparable to those of phosphorous-based chelating agents according to the prior art, and, contrary to the latter, are also biodegradable and thus environmentally friendly.

Stain Removal Tests (Examples 3.2 and 3.3)

As the following examples will show, the polymer of the invention is versatile across several cleaning applications, especially in every domestic and industrial cleaning applications (i.e. laundry and dishwashing), and with several types of stains and spots.

Indeed, the polymer of the invention, when included in detergent compositions, provides effective stain removal in laundry applications in several types of stains (as it can be seen on Example 3.2) and effective spot and film prevention in dishwashing applications (as it can be seen on Example 3.3). Such effective stain removal and spot and film prevention is comparable, or often improved, with respect to known P-free builders and phosphorous-based builders, as it can be seen from Examples 3.2 and 3.3.

### Example 3.2

Laundry Washing Tests

The laundry application test of the present example compares the laundry washing properties of four detergent compositions having the same base (shown on Table 2) and different co-builders in the same amounts (shown on Table 3).

TABLE 2

| Chemical name, trade name | Function | % (w/w) |
|---|---|---|
| LAS (Linear Sodium Alkyl | Anionic Surfactant | 8.8 |
| Benezene Sulfonate) | | |
| Ethoxylated Fatty Alcohol | Non ionic surfactant | 4.7 |
| C12-18 (7EO) | | |
| Sodium soap | Anionic Surfactant | 3.2 |
| Sodium aluminium silicate | Builder | 28.3 |
| zeolite 4A | | |
| Sodium carbonate | Builder/Alkali | 11.6 |
| Na Percarbonate | Bleach | 15.0 |
| TAED | Bleach Activator | 1.5 |
| (tetraacetylethylenediamine) | | |
| Sodium salt of a co-polymer of | Co-builder | 3.0 |
| acrylic and maleic acid | | |
| Protease | Enzyme (Protease) | 0.4 |
| Sodium silicate | Builder | 3.0 |
| Carboxymethylcellulose | Anti-redeposition | 1.2 |
| Sulphate | Filler | q.s. |
| / | Total | 99.4 |

TABLE 3

| | % as active in |
|---|---|
| Name | detergent composition |
| EDTMPA Na⁺ salt + HEDP | 0.5 + 0.1 |
| Na⁺ salt (comparative) | |
| DTMPA Na⁺ salt + HEDP Na⁺ | 0.5 + 0.1 |
| salt (comparative) | |
| EDDS (comparative) | 0.6 |
| Polymer of the invention | 0.6 |

The polymer of the invention used for the present example is the one prepared in Example 1.1 above.

EDTMPA (ethylenediamine tetra (methylene phosphonic acid)) Na⁺ salt+HEDP (1-hydorxyethylidene (1,1-diphosphonic acid)) Na⁺ salt (comparative) and DTMPA (diethylenetriamine penta (methylene Phosphonic acid) Na⁺ salt+HEDP Na⁺ salt (comparative) contain phosphate and are standard and known phosphonate mixtures comprised in European powder detergent compositions. EDDS (ethylenediaminedisuccinic acid) (comparative) is a P-free chelating agent, biodegradable but expensive, can also be comprised in European powder detergent compositions.

Each detergent composition (containing the different co-builders of Table 3) is tested as follows:
water hardness=25° fH (Ca:Mg—2:1);
temperature=40° C.;
Miele washing machines (cotton program);
4 cycles washes (external replication);
stains: selection of 9 stains from the minimum AISE (International Association for Soaps, Detergents and Maintenance Products) protocol: blueberry, grass, red wine, espresso coffee, chocolate drink, cooked beef, sheep blood, fluid make up and squeezy mustard;
detergent composition dosage: 65 g;
performance check by stain removal.

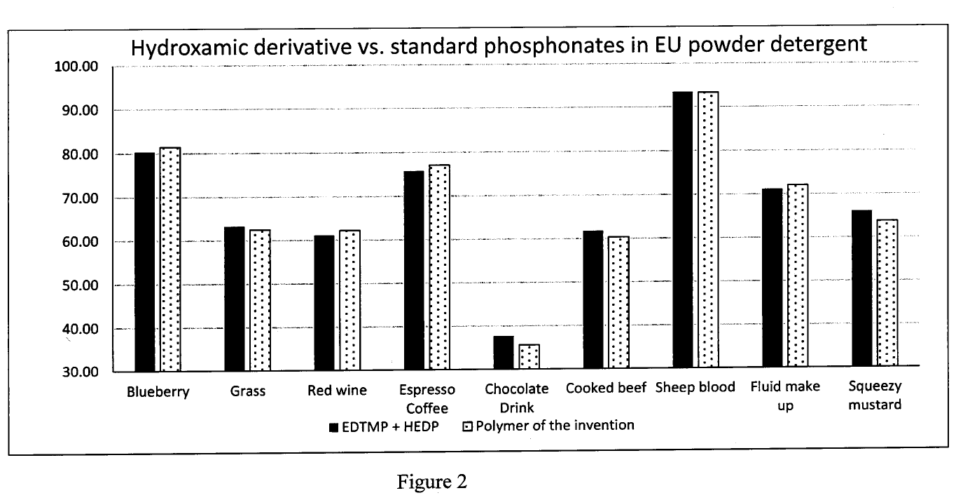

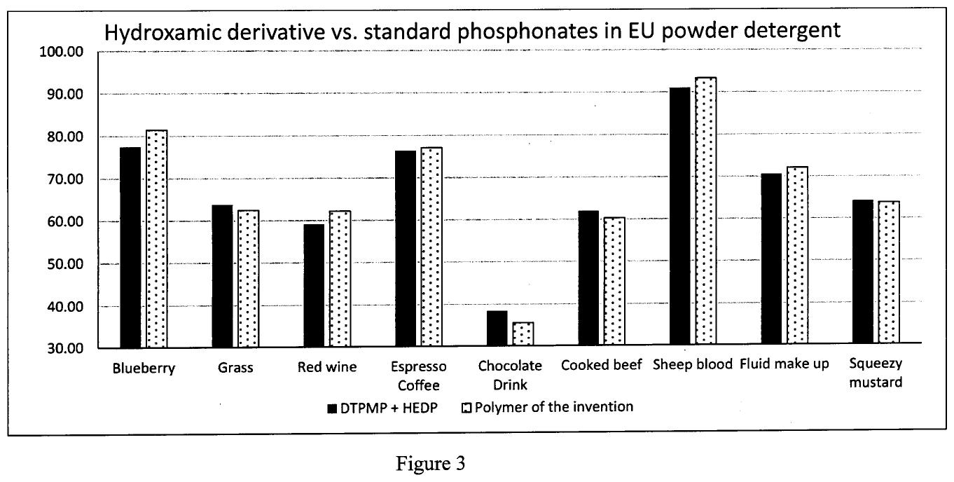

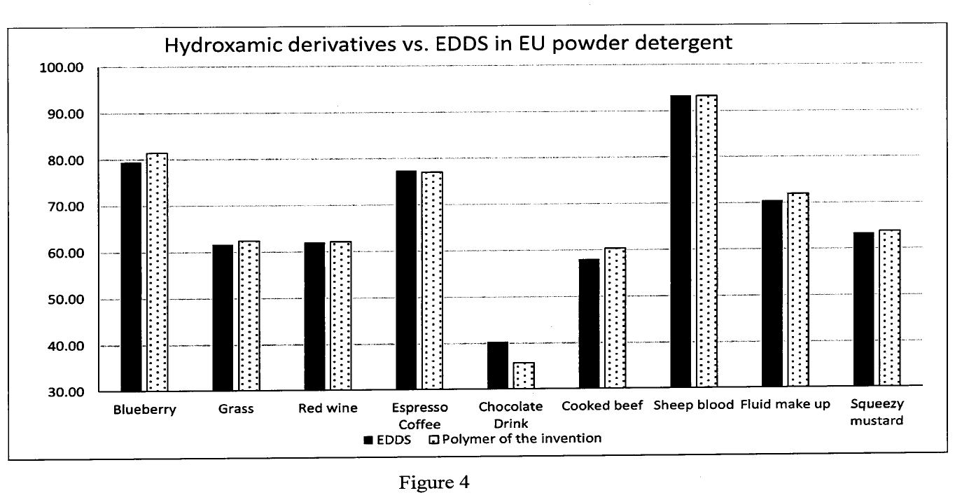

Results of the present example are shown in the graphics on FIGS. 2, 3 and 4. In particular, the polymer of the invention is compared with: EDTMPA Na⁺ salt+HEDP Na⁺ salt (comparative) in FIG. 2, DTMPA Na⁺ salt+HEDP Na⁺ salt (comparative) in FIG. 3, and EDDS (comparative) in FIG. 4.

For the determination of the Y-axis values (i.e. the SRI-values) of the graphics of FIGS. 2 to 3, the standard protocol “Minimum protocol for comparative detergent performance testing, v.5. —November 2013” was used as defined by the A.I.S.E. Working Group: “Laundry Detergent testing”.

Results of the present example show improved performances between detergent compositions comprising the polymer of the invention and detergent compositions comprising co-builder benchmarks on bleachable stains (i.e. blueberry, grass, red wine, espresso coffee, squeezy mustard), and comparable performances on every other tested stain. This proves the versatility of the polymer of the invention, as it can effectively remove several types of stains in laundry applications, and it can effectively prevent several types of spots and films in dishwashing applications too (as it will be shown in the following example).

### Example 3.3

Dishwashing Tests

The dishwashing test of the present example compares the spotting and filming prevention of two detergent compositions. Such two detergent compositions consist of the same base (“Base A”) and different co-builders. “Base A” of the tested detergent compositions is represented on Table 4.

TABLE 4

| Chemical name, trade name | Function | % (w/w) |
|---|---|---|
| Na Citrate | Builder/Chelant | 15.0 |
| MGDA (methylglycindiacetic | Builder/Chelant | 15.0 |
| acid) | | |
| Na Carbonate | Builder/Alkali | 20.0 |
| Na Bicarbonate | Builder/Alkali | 25.0 |
| Silicate SKS ®-6 | Corrosion inhibitor | 3.0 |
| Na Percarbonate | Bleach | 12.0 |
| TAED | Bleach Activator | 2.0 |
| (tetraacetylethylenediamine) | | |
| Non ionic low foaming | Non ionic surfactant | 3.0 |
| surfactant | | |
| Protease | Enzyme (Protease) | 0.5 |
| Amylase | Enzyme (Amylase) | 0.5 |
| Sulphonated co-Polymer | Co-builder | 3.0 |
| Sulphate | Filler | q.s. |
| / | Total | 99.4 |

Last 0:6% of the two detergent compositions comprising “Base A” is a co-builder, in particular is either HEDP Na⁺ (comparative) or the polymer of the invention, as shown on Table 5.

TABLE 5

| Chemical name, trade name | Function | Base A % |
|---|---|---|
| HEDP Na⁺ (comparative) | Co-builder | 0.6 |
| or Polymer of the invention | | |

The polymer of the invention used for the present example is the one prepared in Example 1.1 above.

HEDP is a known phosphorus based additive in cleaning and is present in several conventional detergent composition, according to the prior art.

The two detergent compositions comprising “Base A” are tested as follows:
water hardness=25° fH (Ca:Mg—2:1);
Miele dishwashing machines (daily wash program);
number of washes: 5 cumulative;
number of glasses: 3;
detergent composition dosage: 18 g;
dirt: 20 g.

The dirt is prepared by mixing all the ingredients of Table 6 with a food processor.

TABLE 6

| Component | Quantity | |
|---|---|---|
| Ketchup | 25 | g |
| Mustard | 25 | g |
| Gravy | 25 | g |
| Potato starch | 5 | g |
| Egg yolk | 3 | g |
| Margarine | 100 | g |
| Milk | 50 | ml |
| Water | 700 | ml |

The performance checked on the present example is the spotting and filming prevention of the detergent compositions.

Results are evaluated with a panel test on glasses, and the ranking is from 1 (poor) to 10 (excellent).

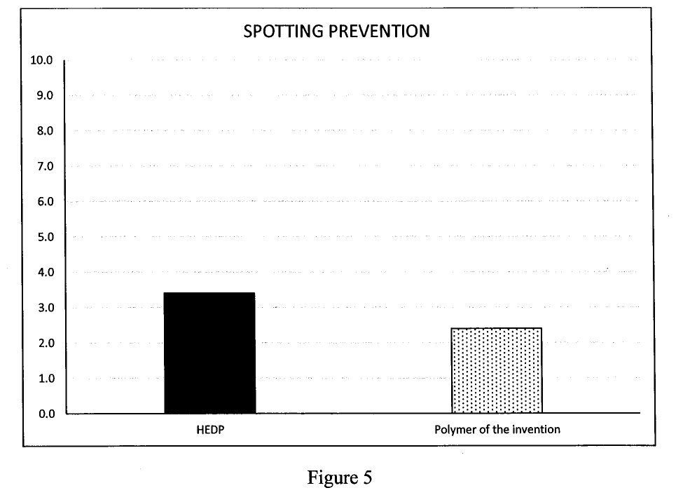

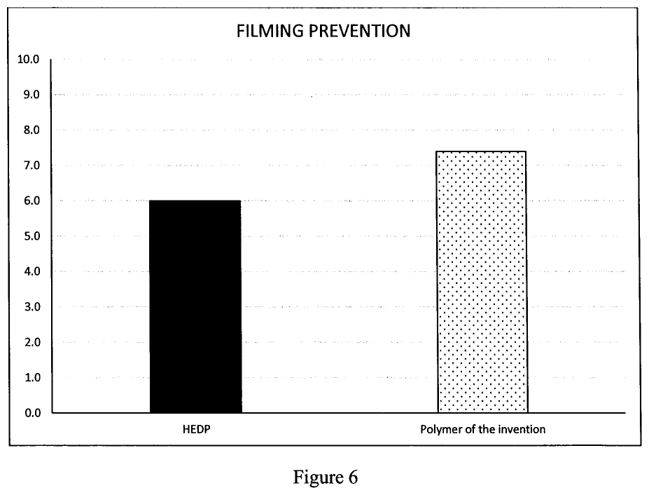

Results of the present test for the detergent compositions comprising “Base A” are reported in FIG. 5 (spotting prevention) and FIG. 6 (filming prevention).

Another dishwashing test is carried out on other two detergent compositions. Such two other detergent compositions consist of the same base (“Base B”) and different co-builders. “Base B” of the detergent compositions is represented on Table 7.

TABLE 7

| Chemical name, trade name | Function | % (w/w) |
|---|---|---|
| Na Citrate | Builder/Chelant | 30.0 |
| Na Carbonate | Builder/Alkali | 20.0 |
| Na Bicarbonate | Builder/Alkali | 25.0 |
| Silicate SKS-6 | Corrosion inhibitor | 3.0 |
| Na Percarbonate | Bleach | 12.0 |
| TAED | Bleach Activator | 2.0 |
| (tetraacetylethylenediamine) | | |
| Non ionic low foaming | Non ionic surfactant | 3.0 |
| surfactant | | |
| Protease | Enzyme (Protease) | 0.5 |
| Amylase | Enzyme (Amylase) | 0.5 |
| Sulphonated co-Polymer | Co-builder | 3.0 |
| Sulphate | Filler | q.s. |
| / | Total | 99.4 |

Last 0.6% of detergent compositions comprising “Base B” is a co-builder, in particular is either HEDP Na⁺ (comparative) or the polymer of the invention, as represented on Table 4 above.

Testing conditions, dirt composition, performance check and evaluating methods of the dishwashing test on the two detergent compositions comprising “Base B” are the same as the ones of the dishwashing test carried out with the detergent compositions comprising “Base A”.

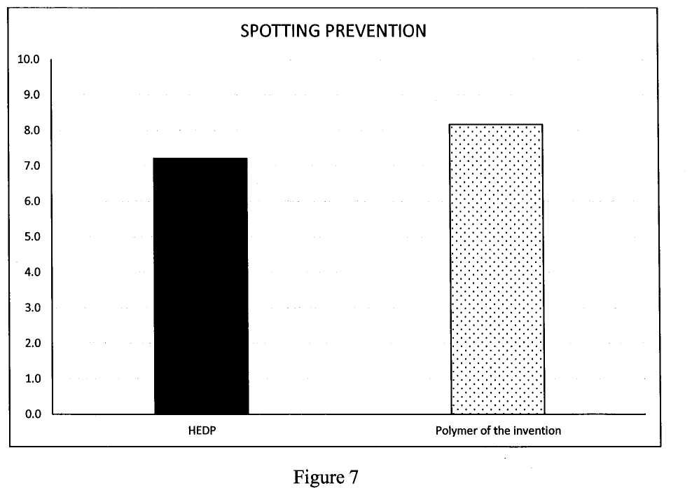

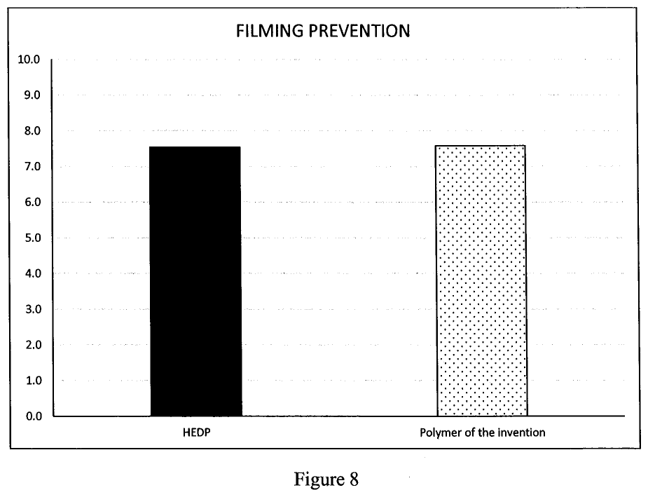

Results of the test for the detergent compositions comprising “Base B” are reported in FIG. 7 (spotting prevention) and FIG. 8 (filming prevention).

From the results of these dishwashing tests represented from FIG. 5 to FIG. 8, it can be concluded that a detergent composition comprising the polymer of the invention provides improved spotting and filming prevention when compared to the same detergent composition comprising conventional phosphonate co-builders.

These results also confirm the versatility of the polymer of the invention: indeed, the polymer of the invention grants suitable dishwashing properties when comprised in different detergent compositions having different bases.

### Example 4

Biodegradation Tests

Biodegradation tests are performed using the standard “closed bottle” methods in accordance with OECD Guidelines 301 B, 301 F and 301 D (Ready Biodegradability), as well as OECD Guidelines 306 (Biodegradability in Seawater—Closed Bottle Method).

Full details of procedures and methods of calculation are publicly available in OECD Guideline for Testing of Chemicals 301 B, 301 F, 301 D and 306.

Study report LC-0053 and LC-0051 for OECD 306, study report LC-0050 and LC-0052 for OECD 301D all available.

Tests result are provided in Table 8 as percentage of biodegradation.

TABLE 8

| | OECD | OECD | OECD | OECD |
|---|---|---|---|---|
| / | 301B | 301F | 301D | 306 |
| Polymer of the invention (Ex 1.5) | 25 | 32 | | |
| Polymer of the invention (Ex 1.6) | 22 | 24 | | |
| Polymer of the invention (Ex 1.3) | | | 79.48% | 62.82% |
| lot 18E122 | | | | |
| Polymer of the invention (Ex 1.3) | | | 87.55% | 82.85% |
| lot 18G088 | | | | |
| Pasp (1) (comparative) | 54 | 50 | | |
| Pasp (2) (comparative) | | | 80.71% | |
| Baypure ® DS100/40% | | | 67.92% | |
| (comparative) | | | | |
| Carboxyline ® CMI | | | | >20% |
| (comparative) | | | | |

Baypure® DS100/40% is polyaspartate available from Lanxess, DE and Carboxyline® CMI is carboxymethylinulin from Cosun, NE. Pasp (1) and (2) were obtained directly from hydrolysis of the polysuccinimide used as raw material to produce SPE1504.

1. An aspartic acid/N-hydroxyaspartamide/succinimide polymer and/or its salts, wherein said polymer comprises non-hydrolyzed succinimide units.

2. The polymer according to claim 1, wherein said succinimide units are comprised in the range of 10% to 90% with respect to the total number of repeat units in the polymer.

3. The polymer according to claim 1 of any of Formula I 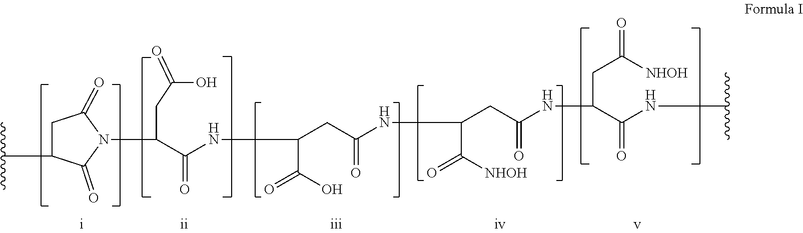
wherein repeat units are randomly bonded in said polymer.

4. The polymer according to claim 1, wherein its molecular weight is comprised in the range of 400 to 5000 Da

5. A detergent composition characterized in that it comprises the polymer according to claim 1 and suitable excipients.

6. The detergent composition according to claim 5, characterized in that it comprises said polymer in an amount comprised in the range from 0.1% to 3% weight/weight (w/w) with respect to the total weight of the composition

7. Method of domestic or industrial cleaning with the polymer according to claim 1, said method comprising
removing stains or spots in domestic or industrial laundry and dishwashing cleaning with said polymer,
wherein said polymer chelates ions from transitional metals.

8. A process for the synthesis of the polymer according to claim 1 comprising the following steps:
a) providing a solution of a salt of hydroxylamine;
b) adding poly-succinimide to said solution of step a), whereby allowing the reaction of said poly-succinimmide with said salt of hydroxylamine; and
c) adding basic reagents, in sub-stoichiometric amount with respect to the initial amount of succinimide units found in the poly-succinimide, in one step or in more than one step after addition of said poly-succinimide in step b) is over;
wherein said process is carried out by controlling the ring opening of said poly-succinimide so that said polymer resulting from step c) comprises non-hydrolyzed succinimide units.

9. The process according to claim 8, wherein said addition of basic reagent of step c) is carried out a temperature comprised in the range of 20° C. to 80° C. for a time comprised in the range of 0.5 to 3 hours.

10. The process according to claim 8, wherein after said addition of basic reagent, the reaction mixture is further kept at a temperature comprised in the range of 20° C. to 80° C. for a time comprised in the range of 0.5 to 3 hours.

11. The process according to claim 8, wherein the molecular weight of said poly-succinimide added in step b) is comprised in the range of 1 to 50 KDa

12. The process according to claim 8, having a molar ratio of hydroxylamine/succinimide repeat units of the starting poly-succinimide of 0.2/1

13. A process for the preparation of an aspartic acid/N-hydroxyaspartamide/succinimide derived polymer and/or its salts, comprising the following steps:
a′) providing a solution of a salt of hydroxylamine;
b′) adding poly-succinimide to said solution of step a′), whereby allowing the reaction of said poly-succinimmide with said salt of hydroxylamine; and
c′) adding basic reagents in one step or in more than one step after addition of said poly-succinimide in step b′) is over;
wherein said process is carried out by controlling the ring opening of said poly-succinimide so that said polymer resulting from step c′) does not comprise non-hydrolyzed succinimide units.

14. The process according to claim 13, wherein basic reagents of step c′) are added in at least three steps and/or are added in a stoichiometric amount or more than stoichiometric amount with respect to the initial amount of succinimide units found in the poly-succinimide.

15. A polymer obtainable according to claim 14.

16. Method of domestic or industrial cleaning with the polymer according to claim 15, said method comprising
removing stains or spots in domestic or industrial laundry and dishwashing cleaning with said polymer,
wherein said polymer chelates ions from transitional metals.
